(19) United States
(12) Patent Application Publication
(10) Pub. No.: US 2011/0104044 A1
(43) Pub. Date: May 5, 2011

(54) DIRECT SYNTHESIS OF AQUEOUS HYDROGEN PEROXIDE SOLUTION AT THE SITE OF A PAPER MILL

(75) Inventor: Jean-Luc Dubois, Millery (FR)

(73) Assignee: Arkema France, Colombes (FR)

(21) Appl. No.: 12/989,835

(22) PCT Filed: Apr. 30, 2009
(86) PCT No.: PCT/FR09/50797

§ 371 Date: Dec. 17, 2010

(30) Foreign Application Priority Data
Apr. 30, 2008 (FR) 0852917

(51) Int. Cl. C01B 15/029; D21C 7/00

(52) U.S. Cl. 423/584; 162/233

(57) ABSTRACT

The invention relates to a plant for producing hydrogen peroxide by direct synthesis (i.e. hydrogen reacts with oxygen in the presence of a catalyst), which is on-site at a paper mill. The invention relates to a method for manufacturing hydrogen peroxide by direct synthesis from hydrogen originating from the recovery of the spent liquor during the manufacture of wood pulp or cellulose pulp.

The present invention relates to a plant for producing hydrogen peroxide by direct synthesis (i.e. hydrogen reacts with oxygen in the presence of a catalyst) which is integrated at a paper mill. It also relates to a process for manufacturing hydrogen peroxide, by direct synthesis, from hydrogen originating from the recovery of the spent liquor produced during the manufacture of wood pulp or cellulose pulp.

This sort of installation is referred to as “integrated” i.e. the hydrogen peroxide is produced on the actual site of its use, in this case a paper pulp mill, by the process of direct manufacture from hydrogen and oxygen in the presence of a catalyst, optionally placed in suspension in an aqueous phase. Furthermore, the hydrogen fed partly or fully to the process for manufacturing hydrogen peroxide originates from the recovery of the spent liquor from the paper pulp mill.

Document EP 666831 describes a process for bleaching a cellulose material with hydrogen peroxide in a plant comprising a spent liquor combustion/gasification unit, a unit for “converting” synthesis gas, a unit for producing hydrogen peroxide and a bleaching unit.

This process comprises the recovery of the spent liquor from a pulp mill to feed a combustion/gasification unit, in which said liquor is partially oxidized or gasified at a temperature above 500° C. to form a gas stream containing hydrogen and carbon monoxide. This gas stream is then subjected to a hydrogen concentration step and then sent to a unit for manufacturing hydrogen peroxide, and the hydrogen peroxide thus formed is fed to a pulp bleaching unit.

The process for manufacturing hydrogen peroxide suggested in document EP 666831 uses the technique of autooxidation of an anthraquinone derivative, of the type comprising a step (a) of catalytic hydrogenation in a hydrogenator of a working solution containing at least one anthraquinone derivative in solution, a step (b) of oxidation of this hydrogenated working solution in an oxidizer, using a fluid containing oxygen, a step (c) of separating hydrogen peroxide and oxidized working solution by water in an extractor, and a step of recycling the oxidized working solution recovered in step (c) to the hydrogenator.

The drawback encountered in the application of a conventional anthraquinone process is that the working solution deteriorates rapidly. Furthermore, this conventional process is very sensitive to the presence of water, even in small amounts, which may be introduced accidentally either in the oxidizer, or in the lines connecting the oxidizer to the extractor. At this level, the water reacts with the oxidized working solution, and this can cause explosive reactions. Moreover, the installation is bulky and the implementation of such a process is rather complex. In fact, it requires several steps and pieces of equipment, as well as a large volume of solvent, called working solution, which conveys the anthraquinone derivative to the installation, and terminates with the extraction of the hydrogen peroxide in water. This process is suitable for producing aqueous solutions of hydrogen peroxide in a concentration higher than about 35% by weight, more generally having a concentration of about 65 to 70% by weight, whereas for paper pulp bleaching applications, an aqueous hydrogen peroxide solution having a concentration lower than 15% by weight, preferably between 5 and 12% by weight, is employed.

It is the object of the present invention to overcome the abovementioned drawbacks.

More particularly, it is the object of the invention to provide an integrated installation for manufacturing hydrogen peroxide at the site of its use, in this case a cellulose pulp manufacturing and bleaching unit, using the process of direct synthesis from hydrogen originating from the recovery of spent liquor produced during the manufacture and bleaching of cellulose pulp.

The integrated installation according to the invention comprises:
(i) a pressurized partial combustion (oxygasification) unit (1), fed with oxygen originating from the separation of air gases from unit (7) and with spent liquor (black liquor) originating from the cellulose pulp manufacturing and bleaching unit (2);
(ii) a unit (3) for purifying all or part of the hydrogen from the off-gas issuing from unit (1);
(iii) optionally, a unit (4) for storing pressurized hydrogen;
(iv) a unit (5) for manufacturing hydrogen peroxide directly from oxygen from unit (7) and from hydrogen originating from the unit (3) and/or the unit (4) in the presence of a catalyst, optionally placed in suspension in an aqueous phase;
(v) optionally, a buffer tank unit (6) for temporarily storing hydrogen peroxide produced in the unit (5);
(vi) the cellulose pulp manufacturing and bleaching unit (2) is fed with hydrogen peroxide from the unit (5) and/or the unit (6).

Since the manufacturing and bleaching unit (2) requires a hydrogen peroxide flow rate that varies in a range that largely exceeds the flexibility of the hydrogen peroxide manufacturing unit (5), a buffer tank unit is provided to tap off a variable flow rate of hydrogen peroxide in order to feed the manufacture and bleaching unit. The unit (2) can also be fed with hydrogen peroxide via a direct hydrogen peroxide line from the unit (5).

The present invention also provides a process for producing hydrogen peroxide at the site of its use, in this case a unit for manufacturing and bleaching cellulose pulp, directly from hydrogen and oxygen in the presence of a catalyst, optionally placed in suspension in an aqueous medium, in which said hydrogen is recovered from the spent liquor produced by said unit.

The aqueous medium preferably has an acidic pH and may comprise hydrogen peroxide stabilizers, surfactants, preferably fluorinated, and halide derivatives selected from alkali metal bromides and chlorides, hydrobromic acid, hydrochloric acid, and bromine in the gas state or in solution in water (bromine water).

When the medium comprises halide derivatives, bromide is preferably used, advantageously in combination with bromine in the free state (Br₂).

The process for direct production of hydrogen peroxide can be implemented at a temperature between ambient temperature and 60° C., preferably lower than 45° C., and at a pressure higher than atmospheric pressure, preferably between 10 and 80 bar and advantageously between 20 and 50 bar.

The process for direct manufacture of hydrogen peroxide can be implemented in continuous or batch mode, in a tubular reactor, a stirred reactor, a membrane reactor, a reactor with a circulation loop, or in a microreactor.

When the process is implemented in a tubular reactor, hydrogen and oxygen are injected in the form of small bubbles at very high speed into the reactor completely filled with aqueous solution at acidic pH. Reference can be made to documents WO 92/04277 and WO 96/05138.

When the process is implemented in a reactor with circulation loop, for example by the Buss ChemTech loop-reactor technology, hydrogen and oxygen are either injected together into the unit or at different points, for example using the staging of the points where gases are injected in the form of small bubbles into an aqueous reaction medium. The wide dispersion of the bubbles in the medium is made possible by the liquid flow velocity.

When the process is implemented in a stirred reactor, preferably vertical and cylindrical, hydrogen and oxygen are injected in the form of small bubbles into an aqueous reaction medium made acidic by the addition of an inorganic acid. The stirred reactor is equipped with means for injecting gaseous reactants at the bottom, and top exit means for removing the gaseous reactants. The reactor is preferably equipped with a plurality of centrifugal turbines disposed along a single stirring shaft. Reference can be made to documents WO 99/41190 and WO 01/05498.

The catalyst used is generally a supported catalyst based on at least one metal selected from the group of noble metals formed by palladium, platinum, ruthenium, rhodium, iridium, osmium, holmium and gold. A supported bimetal catalyst comprising palladium and platinum is preferably used.

The spent liquor is preferably subjected to a pressurized partial oxidation in unit (1), preferably between 20 and 60 bar, advantageously between 30 and 50 bar, in the presence of molecular oxygen, preferably having a purity equal to or higher than 92% and advantageously higher than 99.5% by weight, obtained by the separation of air gases in unit (7). The spent liquor is simultaneously converted to green liquor and synthesis gas in unit (1). The green liquor is recycled to the cellulose pulp manufacturing and bleaching unit (2).

The unit (1) can be fed partly or completely by other biomass sources such as glycerol, wood or oils produced by the pyrolysis of straw.

As the separation technique of unit (7), mention can be made of cryogenic distillation, gas permeation which exploits a preferential permeability to one of the components of the mixture to be separated across a membrane, or adsorption, which exploits a preferential fixation of one or more components of the mixture on an adsorbent which is generally a zeolite molecular sieve, but use can also be made of a carbon molecular sieve, or even a combination of both.

Hydrogen is then separated from the partial oxidation off-gas from unit preferably comprising 25-45% by weight of hydrogen, 18-45% by weight of carbon monoxide, 7-32% by weight of carbon dioxide, 0.5 to 2% by weight of sulfur compounds (in particular H₂S), after optional removal of the acidic gases, essentially carbon dioxide and hydrogen sulfide, in particular by chemical and/or physical absorption.

In the case of chemical absorption, the absorbed gases are liberated by increasing the temperature and reducing the pressure. The most common absorbents are alkanolamines (monoethanolamine: MEA; diethanolamine: DEA), alkali metal salts (sodium or potassium hydroxides).

In the case of physical absorption, the acidic products are absorbed in a solvent which is regenerated by expansion. The most common solvents are methyl ether, propylene glycol and methanol.

After separation, all or part of the hydrogen is purified, for example by adsorption, and optionally part or all of the hydrogen is purified by methanation to convert the carbon monoxide (a poison of the catalysts for direct synthesis of hydrogen peroxide) and the residual carbon dioxide to methane. Preferably, only part of the hydrogen produced by the oxygasification unit is used for the hydrogen peroxide manufacturing process. In this case, it is preferable to recover by adsorption only part of the hydrogen contained in the synthesis gas, but with a high purity. The rest of the hydrogen and the carbon monoxide and dioxide separated in the purification unit are remixed with the main stream of synthesis gas downstream or upstream of the gas separation unit.

In the case in which a high hydrogen consumption is required, the synthesis gas stripped of the sulfur impurities can be sent to a unit called a water gas conversion unit, which converts all or part of the carbon monoxide to hydrogen and carbon dioxide by reaction with water vapor. This operation has the effect of increasing the production of hydrogen and decreasing the carbon monoxide concentration. The hydrogen-rich gas thus produced can be purified by removing the carbon dioxide present and the traces of remaining carbon monoxide by the methods described above.

According to one embodiment, the hydrogen pressure after the purification step is close to the pressure used for the direct synthesis of the hydrogen peroxide.

The integrated installation of the present invention has the advantage of being compact and hence of reducing the investment-related cost. In particular, the integration of the various steps of the process on the same site, for the production of hydrogen peroxide, eliminates the need to invest in an air gas separation unit and in a hydrogen production unit, for example by catalytic reforming of methane or of natural gas. In fact, the air gas separation unit is required for the gasification of the biomass (black liquor for example) which itself produces pressurized hydrogen.

The integrated process of the present invention has an environmental advantage. This is because integrated production eliminates the need to transport the hydrogen peroxide from the plant to the consumption site. Large amounts of energy are consumed during the transport of aqueous hydrogen peroxide solutions because they have concentrations between 35 and 70%, and very often concentrations close to 50% by weight, the remainder consisting of water. Transporting aqueous hydrogen peroxide solution thus involves transporting water, which is not useful in the downstream processes. The integrated production of aqueous hydrogen peroxide solution therefore has a first environmental advantage in terms of transport-related greenhouse gas emissions. A further environmental advantage of the method according to the invention is associated with the greenhouse gas emissions connected with the process itself: the steam reforming of natural gas coproduces about 10 kg of CO₂ per kg of hydrogen produced. This figure may increase to 25 kg of CO₂ per kg of hydrogen when the hydrocarbon source is a heavy refinery residue. The processes using these hydrogen sources and hence fossil carbon yield hydrogen peroxide accompanied by a particularly high production of associated greenhouse gases. According to the process of the present invention, the CO₂ emissions associated with the process do not contribute to global warming because the carbon source is renewable. The plant, for example a tree, has pumped atmospheric CO₂ for its growth, and has metabolized it for example in the form of cellulose. The hydrogen peroxide produced by the inventive process does not contribute to global warming or contributes less thereto.

A further environmental advantage of the process is associated with the absence of a working solution consisting of organic solvents, because the hydrogen peroxide is directly synthesized in water. Hence there is no risk of accidental dispersion of solvents in the environment, which is particularly problematic with isolated production facilities, such as paper mills.

1. (canceled)

2. The process as claimed in claim 8, characterized in that the aqueous medium has an acidic pH.

3. The process as claimed in claim 8, characterized in that the aqueous medium comprises hydrogen peroxide stabilizers and surfactants.

4. The process as claimed in claim 8, characterized in that the hydrogen is obtained by pressurized partial oxidation of the spent liquor.

5. The process as claimed in claim 4, characterized in that the hydrogen is purified.

6. The process as claimed in claim 8, characterized in that the hydrogen peroxide is used in a unit for manufacturing and bleaching cellulose pulp.

7. An integrated installation for manufacturing hydrogen peroxide comprising:
(i) a pressurized partial combustion, oxygasification unit (1), fed with oxygen from an air gases separation unit (7) and spent liquor (black liquor) from a cellulose pulp manufacturing and bleaching unit (2);
(ii) a hydrogen purification unit (3) for purifying hydrogen off-gas from said pressurized partial combustion unit (1);
(iii) optionally, a hydrogen storage unit (4) for storing pressurized hydrogen;
(iv) a hydrogen peroxide unit (5) for manufacturing hydrogen peroxide from oxygen from said air gases separation unit (7) and hydrogen from said hydrogen purification unit (3) and/or said hydrogen storage unit (4) in the presence of a catalyst, said catalyst optionally placed in suspension in an aqueous phase;
(v) optionally, a buffer tank unit (6) for temporarily storing hydrogen peroxide produced in said hydrogen peroxide unit (5);
(vi) said cellulose pulp manufacturing and bleaching unit (2) fed with hydrogen peroxide from said hydrogen peroxide unit (5) and/or said buffer tank unit (6).

8. A process for producing hydrogen peroxide in a cellulose pulp manufacturing ansd bleaching system comprising:
(i) recovering hydrogen from spent (black liquor) produced by said system;
(ii) reacting said hydrogen with oxygen in the presence of a catalyst, said catalyst optionally in suspension in an aqueous medium.
